(19) United States
(12) Patent Application Publication
(10) Pub. No.: US 2015/0296238 A1
(43) Pub. Date: Oct. 15, 2015

(54) METHOD AND APPARATUS FOR PROVIDING AND MANAGING PERSONALIZED CHANNELS

(71) Applicant: THOMSON LICENSING, Issy de Moulineaux (FR)

(72) Inventor: Regine Jeanne LAWTON, Newbury Park, CA (US)

(21) Appl. No.: 14/678,212

(22) Filed: Apr. 3, 2015

Related U.S. Application Data
(60) Provisional application No. 61/977,674, filed on Apr. 10, 2014.

(51) Int. Cl. H04N 21/2668; H04N 21/475; H04N 21/258; H04N 21/482; H04N 21/239; H04N 21/262

(52) U.S. Cl. CPC H04N 21/2668; H04N 21/2393; H04N 21/26258; H04N 21/25891; H04N 21/25883; H04N 21/4821; H04N 21/4755

(57) ABSTRACT

A method for managing content delivery to content consumers commences by initially establishing for at least one content consumer a set of personalized content channels via which the at least one user can access content in accordance with personal preferences. At least one of the one of the set of initially established personalized content channels undergoes modification (addition or deletion) in accordance with at least one attribute of other content consumers.

### TECHNICAL FIELD

This invention relates to a technique for managing personalized channels that provide access to content according to user preferences.

### BACKGROUND ART

Content delivery networks operated by cable television providers, satellite television purveyors, over the top content providers such as the M-Go content delivery service from Technicolor, and telecommunication companies provide users of such networks a plethora of audio-visual content, such as movies and television programs. The content delivery network operators typically provide such content via hundreds of separate channels, many of which cater specific subjects, such as sports, home improvement, history, drama, romance, and the like. The large number of available channels can overwhelm users who incur difficulty organizing content related to a particular preference.

Thus, a need exists for a technique for enabling network users to personalize content relevant to them and their interests.

### BRIEF SUMMARY OF THE INVENTION

Briefly, in accordance with an embodiment of the present principles, a method for managing content delivery to content consumers commences by initially establishing for at least one content consumer a set of personalized content channels via which the at least one user can access content in accordance with personal preferences. At least one of the one of the set of initially established personalized content channels undergoes modification in accordance with at least one attribute of other content consumers.

### BRIEF DESCRIPTION OF THE DRAWINGS

FIG. 1 depicts a block schematic diagram of an exemplary system for delivering content to users

FIG. 2 depicts a block schematic diagram of an exemplary first device for receiving content from the system of FIG. 1;

FIG. 3 depicts a block schematic diagram of an exemplary second device for receiving content from the system of FIG. 1; FIG. 4 depicts a screen shot of a Graphical User Interface (GUI) for managing content delivery to users of the system of FIG. 1;

FIG. 5 depicts in flow chart form a method for create and managing personalized channels in accordance with the present principles; and

FIG. 6 depicts a screen shot of a portion of the GUI of FIG. for enabling a user to create and manage personal channels using the method of FIG. 5.

### DETAILED DESCRIPTION

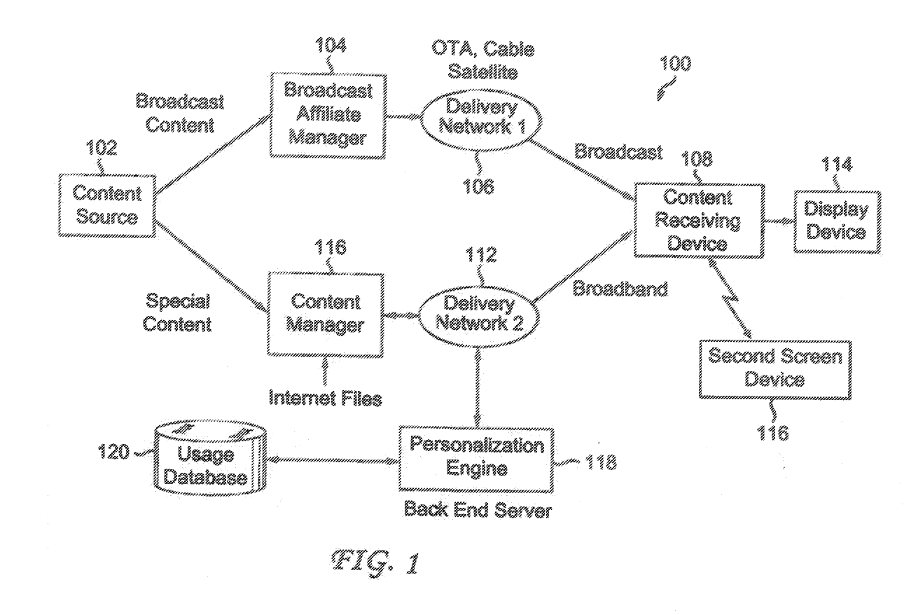

FIG. 1 depicts a block diagram of an illustrative embodiment of a system 100 for delivering content to a user (not shown), and in particular, for delivering content via personalized channels in accordance with the present principles. Such content typically comprises one or audio-visual presentations, including, but not limited to movies, television programs, streaming video or games, for example, that originate from a content source 102 which can deliver content in at least two forms. For example, the content source 102 can deliver content in the form of “broadcast” content of the type formatted for terrestrial broadcast by a broadcast affiliate manager 104, typically a national television broadcast network, such as those operated by American Broadcasting Company (ABC), National Broadcasting Company (NBC), Columbia Broadcasting System (CBS), etc. The broadcast affiliate manager 104 can collect and store the content, and can schedule delivery of that content over a delivery network 106, which can include a wired or wireless communications network or a combination of over-the-air (OTA), cable television and/or satellite communication networks.

The content source 102 can also deliver special content, such as premium or pay-per-view content otherwise not provided to the broadcast affiliate manager 104. For example, such special content can include first run movies offered to users in response to their request (e.g., pay-per-view), or on a subscription basis. Such content can also include archived episodes of television shows provided to the broadcast affiliate manager 104. The content source 102 provides such special content to a content manager 110, which can comprise a service provider, such as an Internet website, affiliated with a content provider, broadcast service, or network delivery service (e.g., cable television or satellite provider or telecommunications carrier). The content manager 110 can also incorporate Internet files for delivery with such special content through an over the top service such as, Nettlix, Amazon and the M-GO content delivery service from Technicolor, Inc. as an example. In practice, the content manager 110 delivers special content (and associated Internet files) over a separate delivery network 112, which can include a Wide-Area Network (WAN), Local-Area Network (LAN) and/or a high-speed broadband communications network, including, but not limited to, the Internet. Note that the content provided by the broadcast affiliate manager 104 could undergo delivery using all or part of delivery network 112 and content from the content manager 110 could undergo delivery using all or part of delivery network 106. In addition, the delivery of content could occur directly via the network 112 without the need for the content manager 110.

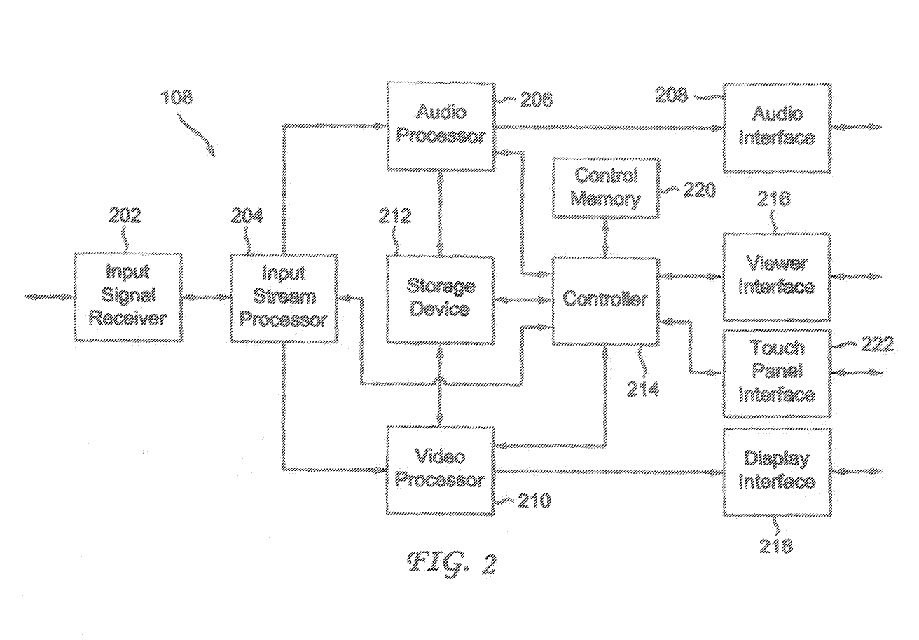

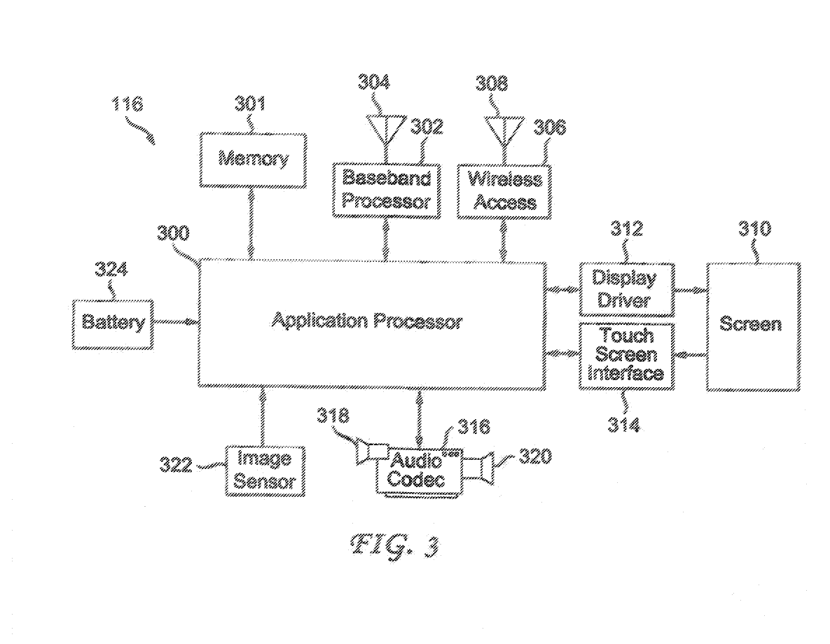

At a local premise, such as a home or the like, a user of the content delivery networks 106 and 112 (e.g., a “viewer”) uses a content receiving device 108 to access (e.g., receive) content via one or both of the networks for processing and subsequent display on a display device 114, such as a television set or the like. In this way, the network user “consumes” content. The content receiving device 108, described greater in detail in FIG. 2, can take many forms, such as a set-top box, gateway, modem or the like. Moreover, the functionality of the content receiving device 108 could reside in devices such as a digital video player (DVR), personal computer, television set, etc. or could take the form of a set top box/digital video recorder (DVR), a gateway, a modem, etc. Further, the content receiving device 108 could act as entry point, or gateway, for a home network system (not shown) that includes additional devices configured as either client or peer devices in the home network (not shown).

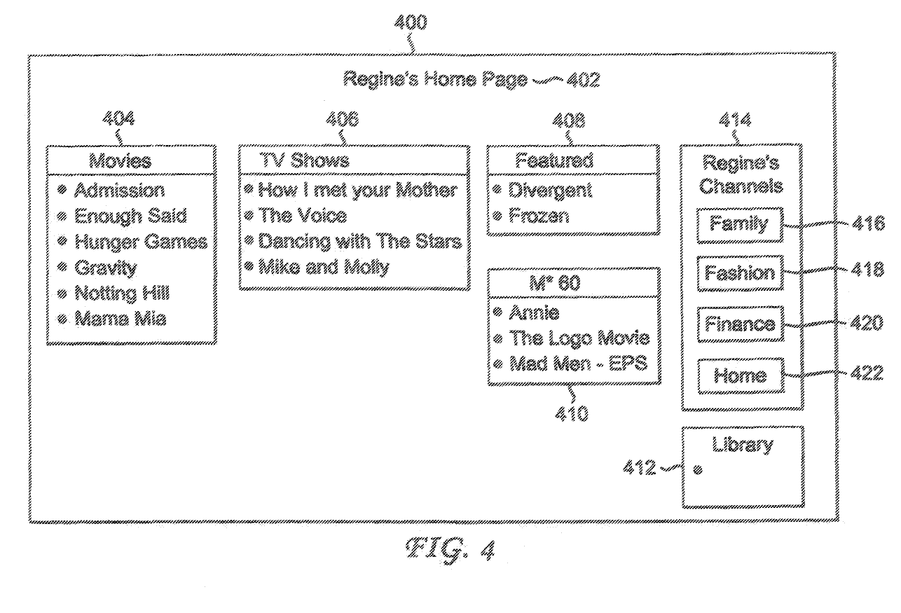

The content receiving device 108 processes the content received via one or both the networks 106 and 112 based on user preferences and commands. The content receiving device 108 can include a storage device, such as a hard drive or optical disk drive (not shown), for content recording and playback. The content receiving device 108 can interface with a second-screen device 116, described in greater detail with respect to FIG. 3. The second-screen device 116 allows the user to control both the content receiving device 108 and the display device 114, Further, the second-screen device 116 also has the capability to display the same or related content in synchronism with the content displayed on the display device 114. The second-screen device 116 allows the user to interact with the content. For subsequent reference, the content receiving device 108 constitutes a “first” content receiving device, whereas the second screen device 116 constitutes a “second” content receiving device.

The system 100 includes a back-end server 18 and a usage database 120. The back end server 118 performs the function of a personalization engine that analyzes the usage habits of users and makes recommendations for content based on those habits. The usage database 120 stores user data indicate viewing habits and stores user profiles generated by the server 118. The back-send server 118 can perform billing and/or authentication functions as well. Other mechanisms (not shown) could perform billing and/or authentication in place of the back-end server 118.

FIG. 2 depicts a block schematic diagram of an exemplary embodiment of the content receiving device 108 of FIG. 1. As illustrated in FIG. 2, the content receiving device 108 includes an input signal receiver 202 that receives content via the networks 106 and 112 shown in FIG. 1. The input signal receiver 202 can comprise one of several known receiver circuits used for receiving, demodulating and decoding received content. An input stream processor 204 receives the decoded content and performs the final signal selection and processing, including separation of video from audio in the decoded content. The input stream processor 204 supplies the audio to an audio processor 206, which generates an audio signal for receipt by an audio interface 208 that provides an audio signal to the display device 114 of FIG. 1, or other device(s) (not shown) for audio reproduction. Typically, the audio interface 208 generates an analog audio signal. Alternatively, the audio interface 208 could generate a digital signal. Additionally, the audio processor 206 supplies audio signals to a storage device 212 for storage.

The input stream processor 204 also provides a video output signal to a video processor 210, which undertakes signal conversion to provide a video signal of the appropriate format for storage in the storage device 212 and for display. A display interface 218 interfaces the video processor 210 to the display device 114 of FIG. 1. The storage device 212 stores content audio and video for later retrieval and playback of the content under the control of a controller 214 in accordance with commands received by the user through a user interface 216 and/or a touch panel interface 222. The user interface 216 can provide an interface to a touch panel (not shown) separate from, or integrated with the display device 114 of FIG. 1. Additionally, the user interface 216 provides the mechanism by which the second-screen control device 116 of FIG. 1 interfaces to the controller 214. The storage device 212 can comprise be a hard disk drive, one or more large capacity integrated electronic memories, such as static RAM (SRAM), or dynamic RAM (DRAM), or an interchangeable optical disk storage system such as a compact disk (CD) drive or digital video disk (DVD) drive.

The controller 214 controls the operation of the content receiving device 108. To that end, the controller 214 has bus interconnection to the input stream processor 202, the audio processor 206, the video processor 210, the storage device 212, the user interface 216 and the touch panel interface 222. The controller 214 manages the conversion process for converting the input stream signal into a signal for storage on the storage device 212 and/or display. The controller 214 also manages the retrieval and playback of stored content.

The controller 214 also has a bus interconnection to a control memory 220 (e.g., one or more volatile and/or non-volatile memories, including RAM, SRAM, DRAM, ROM, Programmable ROM (PROM), flash memory, Electronically Programmable ROM (EPROM), electronically erasable Programmable ROM (EEPROM), etc.), for storing information and instruction code for the controller 214. The control memory 220 can also store a database of elements, such as graphic elements, for generating a graphical user interface for display to the user on the display device 114 of FIG. 1.

In practice, the second-screen control device 116 can take a variety of forms. For example, the second-screen control device 116 could take the form of a tablet device, such as the Apple I-Pad, or Samsung Galaxy Note tablet. Alternatively, the second-screen control device 116 could take the form of a smart phone or laptop computer or any other similar device that can send and receive data as well as display of such data. A block schematic diagram of an exemplary second-screen device 116, in the form of a smart phone, appears in FIG. 3. The second-screen device 116 of FIG. 3 includes an application processor 300, which controls overall operation of the device. To that end, the application processor 300 has a connection to a memory block 301, which can include one or more of the following types of memory (not shown), flash card, mobile DRAM, Memory Multi Chip Package (MCP), and Multimedia Card Memory (MMC), which collectively store the operating system for the application processor as well as application programs and data.

The application processor 300 interfaces with a baseband processor 302, which connects to an antenna 304. The baseband processor 302 includes circuitry (not shown) for receiving and transmitting RF signals within the frequency range designated for cellular communication to allow the second-screen device 116 to operate as a cellular telephone for voice and/or data communication. The application processor 300 also interfaces with a wireless access block 306 that connects to an antenna 308. The wireless access block 306 operates in a manner similar to the baseband processor 302 to receive and transmit RF signals, except that the wireless access block operates in both the Bluetooth and Wi-Fi frequency band.

The second-screen device includes a display screen 310, typically an LCD or OLED screen, driven by the application processor 300 via a display driver circuit 312. In addition to its display functionality, the screen 310 has a data input capability to allow an operator to touch the screen to enter data to the application processor 300 via a touch screen interface 314.

The application processor 300 interfaces with an audio codec 316 connected to a microphone 318 and a speaker 320. The audio codec 316 processes voice signals from the microphone 318 for receipt by the application processor 300 to allow the user of the second-screen device to enter voice commands as well as converse with another caller when the second-screen device operates as a cell phone. The audio codec also process signals from the application processor 300 for audio reproduction by the speaker 320.

In the illustrated embodiment, the second-screen device 116 of FIG. 3 also includes an image sensor, typically in the form of a CMOS image sensor 322, coupled to the application processor 300. In an optional embodiment, the image sensor 322 could be configured to accept user input in the form of gestures. The application processor 300 can store images captured by the image sensor 322 in the memory bank 301 for future recall and/or transmission by one of the baseband processor 302 or the wireless access block 306. A power source, in form of a rechargeable battery provides power to the application processor 300 for its use and for distribution to the other elements within the second-screen device 116.

In practice, the wireless access block 306 of the second-screen device 116 of FIG. 3 advantageously communicates with touch panel interface 222 of the content receive device 108 of FIG. 2 via a Wi-Fi channel although the second screen could use Bluetooth instead of Wi-Fi as the communications protocol. In this way, a user using the second-screen device 116 of FIG. 3 can enter commands via the touch screen functionality of the screen 310 to control the content receiving device 108 while viewing content displayed on the screen 310. In addition, the user using the second-screen device 116 could also enter voice commands through the microphone 318 to control the content receiving device 108 of FIG. 2.

In accordance with an aspect of the present principles, the back-end server 118 of the system 100 of FIG. 1 can create and subsequently modify personalized viewing channels for users based on user input commands and the viewing habits of network users, thereby allowing users to access content in accordance with personal preferences. To understand better the manner in which the system 100 of FIG. 1 manages personalized viewing channels, refer to FIG. 4, which depicts a screen shot of a user interface 400 of a typical content consumer (“Regine”) that receives content via one or both of the networks 106 and 112 (both of FIG. 1). The user interface 400 of FIG. 4 can appear on either or both of the devices 108 and 1116 of FIG. 1 and serves as a Graphical User Interface via which the user creates and manages such personal channels.

Referring to FIG. 4, the home page has a heading 402 that identifies the user (e.g., “Regine's Home Page”). In addition to the heading 402, the home page 400 typically includes one or more icons, each associated with a different portal (e.g., content source) for accessing content. In the illustrative embodiment of FIG. 4, the home page 400 includes icons 404-414. The icon 414 corresponds to a “Movies” portal via which the content consumer can access different movies illustratively depicted by the movies Admissions, Enough Said, Hunger Games, Gravity, Notting Hill, and Mamma Mia!. The movies accessed through the “Movies” portal could exist as stored files resident in the content receiving device 108 of FIG. 1 or another storage device (not shown) at the user premise. Alternatively, one or more of these movies listed in the “Movies” portal could exist as a link which, when actuated by the user would trigger an appropriate one of the networks 106 and 112 of FIG. to either stream or download the requested movie.

Various mechanisms exist for populating the “Movies” portal. For example, the content manager 116 of FIG. 1 could communicate a list of available movies to the back-end server 118 of FIG. 1 for inclusion in the “Movies” portal. In addition, the back-end server 118 could select additional movies from the content manager 116 for inclusion in the “Movies” portal, taking into account the user viewing habits. Further, the user could request movies from the content manager 116, via the Internet or another communications channel, for inclusion in the “Movies” portal.

The icon 406 designates a “TV Shows” portal via which the user “Regine” can access episodes of television shows, such as How I Meet Your Mother, The Voice, Dancing with the Stars and Mike & Molly, for example. These television show episodes (as well as episodes of other shows) could exist as stored files resident in the content receiving device 108 of FIG. 1. Alternatively, these television show episodes could exist as links which, when actuated by the user would trigger streaming or downloading of these episodes as requested.

Various mechanisms exist for populating the “Television Shows” portal. For example, the content manager 116 of FIG. 1 could communicate a list of available television show episodes movies to the back-end server 118 of FIG. 1 for inclusion in the “Television Shows” portal. In addition, the back-end server 118 could select additional television shows from the content manager 116 for inclusion in the “Television Shows” portal, taking into account the user viewing habits. Further, the user could request different television show episodes from the content manager 116, via the Internet or another communications channel for inclusion in the “Television Shows” portal.

The icon 408 designates a “Featured” portal via which the user “Regine” can access featured content. As illustrated in FIG. 4, the “Featured” portal identified by the icon 408 provides the user with access to two first-run movies Divergent and Frozen. Unlike the portals associated with the icons 404 and 406, which typically confine themselves to movies and television shows, respectively, the portal associated with the icon 408 provides access to variety of featured content including but not limited to first-run movies. Such featured content could include steaming video and/or games in addition to, or in place of featured movies and television show episodes. The content accessible via the “Featured” portal associated with the icon 408 could exist as stored files resident in the content receiving device 108 of FIG. 1. Alternatively, the content could exist as links which, when actuated by the user would trigger streaming or downloading the featured content as requested. The mechanisms discussed above for populating the other portals could also apply to populating the “Featured” portal as well.

The icon 410 corresponds to a portal via which the user “Regine” can access content from an Over-the-Top (OM content provider as embodied in the form of a content manager) 16 in accordance with the illustrative principles disclosed above. For example, the M-Go content delivery service from Technicolor, Culver City Calif. is an example of an OTT service provider. For this reason, the portal associated with the icon 410 bears the identification “M-GO.” As illustrated in FIG. 4, the M-Go service has a user screen that allows the user to access content from the M-Go content delivery service, as illustratively depicted by the movies Annie and The Lego Movie as well as an episode from the television show Mad Men. The content associated with the M-GO user screen typically exists as links, which, when actuated by the user would trigger streaming of the requested content. Typically, the M-GO content delivery services populates the M-GO portal in response to user content requests received via the Internet or another communications channel,

The home page 400 of FIG. 4 also includes an icon 412 associated with a “Library” portal via which the user can access content stored on the content receiving device 108, or another storage device (not shown) directly accessible by the user. The illustrated embodiment of FIG. 4 depicts the “Library” portal as empty because the user has not yet designated any content for storage. Once the user does designate content for storage, the identity of the stored content will appear in the “Library” portal associated with the icon 412.

The icon 414 designates a “Personal Channel” portal via which a user can create, delete and otherwise manage personalized channels, exemplified by the channels represented by the icons 416-422 depicted in FIG. 4. Each personalized channel constitutes separate content repository, which the user can populate with content according to user interests. Further, in accordance with an aspect of the present principles, the back-end server can create and manage personal channels for a user (and populate such channel(s) with content) based on the usage habits of other users.

In the illustrated embodiment of FIG. 4, the icons 416-422 designate the following channels “Family”, “Fashion”, “Finance”, and “Home”, respectively, personally selected by the user “Regine.” Having established these channels designated by the icons 416-422, the user can then populate channels with content. For example, the user “Regine” could populate her “Home” channel with content related to the home, such television show episodes related to home improvement and/or real estate, by making a request to the content manager 116 for such content. In addition to or in place of such television show episodes, the user could populate the “Home” channel with how-to videos from YouTube or other sources by requesting such content from such sources. The user can populate each of the other channels with content related to the subject matter of such channels in a manner similar to that described for the “Home” channel

The back-end server 118 of FIG. 1 can also populate one or more of the user's channels with content based on the user's past viewing history. For example, when the back-end server 118 detects that the user “Regine” has designated one or television shows for her “Finance” personalized channel, the server can designate related content for that channel as well. The back-end server 118 can designate content for other personalized channels in a similar manner.

The content associated with each personal channel could exist as stored files resident in the content receiving device 108 of FIG. 1. Alternatively, the content could exist as links which, when actuated by the user would trigger streaming or downloading the featured content as requested.

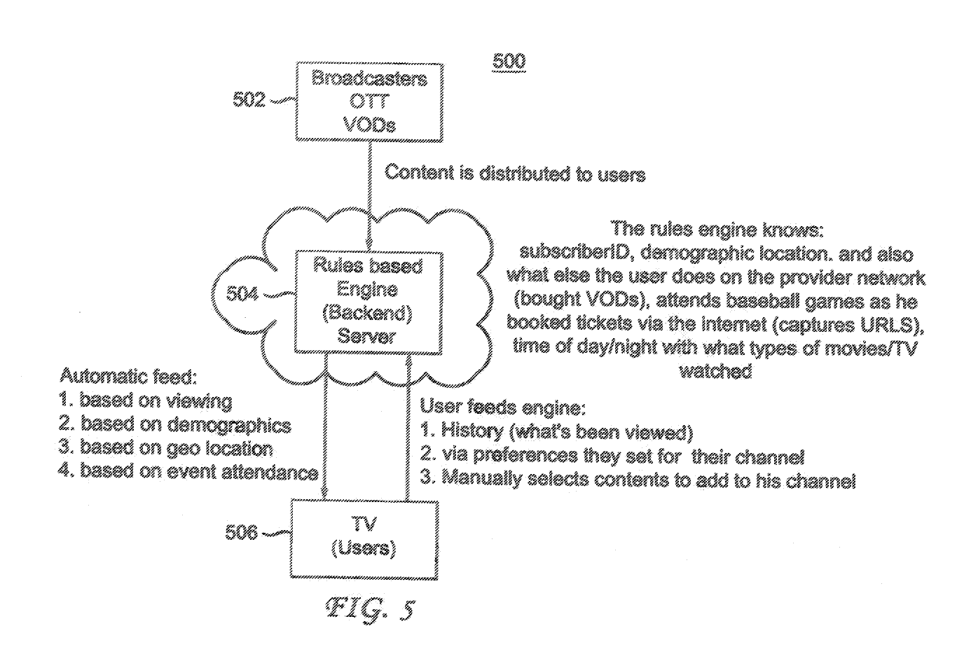

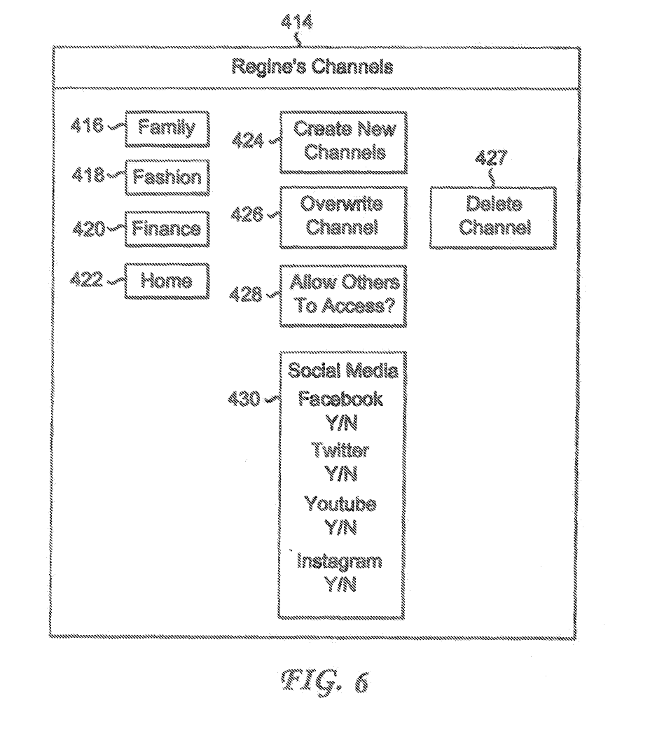

FIG. 5 depicts in flow-chart form the steps of a method practiced by the system of FIG. 1 to create personalized channels. The method commences

FIG. 5 depicts an expanded version of the icon 414 of FIG. 4 associated with the user's personalized channels. In addition to the icon 414 including the icons 416-422 depicting the user's personalized channels, the icon 414 depicts a set of icons 424-430 corresponding to functions utilized by the user to create and manage personalized channels. The icon 424 displays the message “Create New Channel.” By actuating the icon 424, the user can create a new personalized channel. The user could use a remote control (not) shown for the content receiving device 108 of FIG. 1 to actuate the icon and subsequently designate the subject matter for that channel. Alternatively, the user could use the second screen device) 16 for this purpose.

The icon 426 displays the message “Overwrite Channel.” and by actuating this icon, the user can overwrite an existing personalized channel, e.g., the “Fashion” channel depicted by icon 422. The icon 427 displays the message “Delete Channel.” and by actuating this icon, the user can delete an existing personalized channel, e.g., the “Family” channel Fashion” channel depicted by icon 416. The icon 428 displays the message “Allow Others Access” and by actuating this icon, the user can grant other users access to one or more personalized channels. Such access could be unlimited or for a fixed duration. Users accessing other user's personal channels typically do not have permission to delete or overwrite personal channels. Only the user who created a personalized channel has the permission to overwrite or delete such a channel by actuating a corresponding one of the icons 426 and 427, respectively.

The icon 430 lists social media sites, which the user can authorize for access in connection with one or more of the user's personal channels. In the illustrated embodiment of FIG. 4, the icon 430 lists the following social media sites for connection:
Facebook
Twitter
YouTube
Instagram
   Each listed social media site includes a designator “Y/N” which allows the user to authorize a connection to that site. While the icon 430 lists the four social media sites described above, the icon could list a larger or smaller number of sites without departing from the present principles.

As discussed above, the back-end server 118 can also create and modify a user's personal channels based on trends of other users, as determines from the usage habits of such other users. In accordance with the present principles, a user also has the ability to select the conditions under which the back-end server 118 of FIG. 1 can create and modify that user's personal channels. For example, the user could authorize the back-end server 118 to take account of the following characteristics/activities of other users:
a. Demographics (e.g., age, gender, income level etc.)
b. Interests (e.g., hobbies, associations, social network memberships, etc.)
c. Geographic location (street, neighborhood, state)
d. Event attendance (e.g., movies, concerts, social events, etc.)

For example, a user that has similar demographics or interests as other users could authorize the back-end server 118 of FIG. 1 to create the same personal channels as such other users populated with the same content. Likewise, a user in a particular geographic location (e.g., a neighborhood, city, region or state, for example) could choose authorize the back-end server 118 of FIG. 1 to create the same personal channels as other users in the same location populated with the same content. If the user already has one or more personal channels in common with other users that have the same or similar demographics or interests or the same location, the back-end server 118 could populate such channels with content the same as such other users have populated their similar channels.

A user who attends certain events on a regular basis (e.g., baseball games, concerts, opera, and art gallery exhibitions) could authorize the back-end server 118 of FIG. 1 to create the same personal channels other users who attend the same or similar events. If the user already has one or more personal channels in common with other users, the back-end server 118 could populate such channels with content the same as such other users have populated their similar channels.

Note that the criterion discussed above utilized by the back-end server 118 in creating and populating personal channels constitutes merely an example. Those skilled in the art can readily appreciate that the back-end server 118 can use any or all of these criterion as well as one or more other criterion in addition to or in place thereof to establish trends of other users.

A user can also authorize the back-end server 118 to modify (e.g., alter or delete) the personal channels (and the content for such channels) based on the trends of other users. For example, a user could have a previously established personal channel associated with a particular movie actor. However, the back-end server 118 could delete that channel or specific content associated with that channel because other users no longer watch movies made by that actor.

The foregoing describes a technique for managing personalized channels that provide access to content according to user preferences.

1. A method for managing content delivery to content consumer, comprising
the steps of
establishing for at least one content consumer a set of personalized content channels via which the at least one user can access content in accordance with a user preferences; and
modifying at least one of the set of established content consumer personalized content channels in accordance with at least one attribute of other content consumers.

2. The method according to claim 1 wherein the modifying step includes adding at least one additional personalized channel to the initially established set of personalized channels.

3. The method according to claim 1 wherein the modifying step includes deleting at least one personalized channel from the initially established set of personalized channels.

4. The method according to claim 1 wherein the at least one attribute comprises one of other user demographics, interests, geographic location; and event attendance.

5. The method according to claim 1 wherein the modifying step includes modifying content associated with the at least one personalized content channel.

6. The method according to claim 1 wherein the step of modifying content includes adding content.

7. The method according to claim 1 wherein the step of modifying content includes deleting content.

8. Apparatus for managing content delivery to users, comprising,
at least one source of content;
at least one content delivery source for delivering content to at content user;
a server coupled to the content delivery network for (1) initially establishing, in response to a request from at least one user, a set of personalized content channels via which the at least one user can access content in accordance with personal preferences; and (2) modifying at least one of the set of initially established personalized content channels in accordance with at least one attribute of other content consumers.

9. The apparatus according to claim 8 wherein the server modifies the initially established set of personalized channels by adding at least one additional personalized channel to the set.

10. The apparatus according to claim 8 wherein the server modifies the initially established set of personalized channels by deleting at least one additional personalized channel from the set.

1. The apparatus according to claim 8 wherein the at least one attribute comprises one of other user demographics, interests, geographic location; and event attendance.

12. The apparatus according to claim 8 wherein the server modifies the at least one personal channel by modifying content associated with the at least one personalized content channel.

13. The apparatus according to claim 12 wherein the server modifies the content by adding additional content to a channel.

14. The apparatus according to claim 12 wherein the server modifies the content by deleting content from a channel.
